(19) United States
(12) Patent Application Publication
(10) Pub. No.: US 2026/0250506 A1
(43) Pub. Date: Aug. 27, 2026

(54) HYDROPHOBIC METALLIC NANOLABELS FOR POLYESTER PARTICLE LABELING

(71) Applicant: QATAR UNIVERSITY, Doha (QA)

(72) Inventor: Alaaldin Mohammad Alkilany, Doha (QA)

(21) Appl. No.: 19/413,718

(22) Filed: Dec. 9, 2025

Related U.S. Application Data
(60) Provisional application No. 63/763,215, filed on Feb. 25, 2025.

(51) Int. Cl. C08L 67/04; C08K 3/08

(52) U.S. Cl. CPC C08L 67/04; C08K 3/08; C08K 2003/0806; C08K 2003/0831; C08K 2201/003; C08K 2201/005; C08K 2201/014; C08L 2314/00

(57) ABSTRACT

Described herein is a polymer composite comprising a plurality of surface thiolated polylactic acid (PLA) or poly(lactic-co-glycolic acid) (PLGA) functionalized metallic nanoparticles encapsulated in polyester particles useful for drug delivery systems and imaging and diagnostics.

### CROSS-REFERENCE TO RELATED APPLICATIONS

This application claims priority to, and the benefit of, U.S. Ser. No. 63/763,215 filed Feb. 25, 2025, the entirety of which is herein incorporated for all purposes.

### FIELD OF INVENTION

Described herein is a polymer composite comprising a plurality of surface thiolated polylactic acid (PLA) or poly(lactic-co-glycolic acid) (PLGA) functionalized metallic nanoparticles encapsulated in polyester particles useful for drug delivery systems and imaging and diagnostics.

### BACKGROUND

Nanotechnology-based therapeutics and imaging agents approved by the FDA are increasingly being utilized in clinical practice, with many more currently undergoing investigation in clinical trials [1,2]. Furthermore, there is a growing interest in nanoparticle-based therapeutics and imaging agents from both academic and industrial sectors, as evidenced by the rising number of publications, patents, and commercially available nanoparticle-containing products [3,4]. Poly lactic-co-glycolic acid (PLGA), a biocompatible and biodegradable polymer, has led to the development of commercially available drug delivery systems with PLGA-based nanocarriers emerging as one of the most significant and promising platforms for nanotherapeutics [5-7]. To design effective and safe PLGA-based nanotherapeutics, it is crucial to comprehend the interactions of nanoparticles with biological compartments, known as the nano-bio interface. This interface includes biological processes such as the formation of a protein corona on circulating nanoparticles, cellular uptake and efflux, intracellular trafficking, and the pharmacokinetics (absorption, distribution, metabolism, and excretion) of nanotherapeutics [8,9]. A thorough understanding of these molecular processes is essential for engineering optimal nanotherapeutics that maximize efficacy and minimize side effects, thereby enhancing their potential for successful translation into clinical applications.

To understand the nano-bio interface, it is necessary to visualize and quantify nanoparticles within complex biological compartments to address the fundamental queries regarding their distribution and quantity, as well as the impact of nanoparticle and cellular parameters on their biological fate. Finding the proper solution to these critical queries necessitates the use of diverse analytical techniques capable of tracking, visualizing, and quantifying PLGA nanoparticles with high sensitivity, selectivity, and precision [10]. Consequently, various nanoparticle labelling techniques have been developed for both in vitro and in vivo applications, utilizing labels or probes that facilitate imaging through modalities such as fluorescence, magnetic resonance, computed tomography, positron emission tomography, surface-enhanced Raman spectroscopy, photoacoustic imaging, and electron microscopy. Currently, the most common labels are small organic molecules, including chromophores, fluorophores, and radionucleotides, which represent the first generation of these labeling technologies [10-13].

Despite their advantages, current imaging modalities exhibit limitations, particularly in terms of poor spatial resolution and restricted absolute quantification capabilities. To overcome these challenges and address the drawbacks associated with small molecule labels, such as photobleaching, chemical degradation, and desorption-related artifacts, inorganic nanoparticles have recently been utilized as contrast agents or nanoprobes to enhance contrast capabilities [10, 14-16]. For example, Qdot nanoprobes from Invitrogen demonstrate remarkable fluorescence performance by employing quantum dots for cell labeling. Additionally, immunogold, which consists of antibodies labeled with gold nanoparticles, is commercially available and is commonly used to visualize cellular and tissue antigens with high spatial resolution through transmission electron microscopy (TEM) [17]. Similarly, gold nanoparticle (GNP) nanoprobes (20 nm) facilitate high-resolution imaging of polymeric nanocarriers (150 nm) within single cancer cells using TEM, which allows for their precise quantification with an exceptionally low limit of detection through Inductively Coupled Plasma Mass Spectrometry (ICP-MS) analysis [18].

In general, an efficient method for encapsulating GNPs into PLGA nanocarriers should be based on the established techniques typically used for incorporating molecular therapeutics and dyes into PLGA matrices [19]. The most efficient protocol for preparing PLGA nanocarriers is the nanoprecipitation method, which involves dissolving PLGA in an organic solvent that is miscible with water, such as acetone or acetonitrile [19]. The resulting organic PLGA solution added to water (antisolvent for PLGA) leads to rapid precipitation [5]. In the presence of an appropriate surfactant or stabilizing agent, stable PLGA nanocarriers can be formed.

The key challenge lies in engineering ultra-small gold nanoparticles (usGNPs) that remain colloidally stable in an organic solvent, enabling their co-precipitation with PLGA upon introduction to water. To achieve this, as described herein, the surface of the usGNPs is functionalized with the polymer, polylactic acid (PLA), to form the nanocarrier matrix. This approach, has been successfully applied by preparing PLA-capped usGNPs, which demonstrate exceptional stability in acetone/PLGA solutions [18].

Gradual addition of the PLA-usGNP/PLGA/acetone system into water leads to the complete encapsulation of PLA-capped usGNPs within PLGA nanocarriers. This process follows the principle of “like dissolves like” in chemistry and underscores the critical role of the capping agent on the usGNPs in ensuring efficient, reproducible, and complete encapsulation. This encapsulation of PLA-capped usGNPs enable superior particle-to-particle loading homogeneity into the PLGA nanocarriers, yields a uniform and highly efficient nanoparticle loading. The resulting usGNP, with a core diameter of less than 5 nm, functions as an efficient nanoprobe and promotes improved renal excretion, which addresses the major limitation of poor elimination with the larger spherical GNPs following in vivo administration [20, 21].

### SUMMARY

This invention solves the following problem. This innovation addresses several challenges in nanoparticle labeling and functionalization, particularly for hydrophobic polyester particles such as PLA, PLGA, and polylactones. One of the key problems it solves is the poor compatibility of traditional labeling methods with hydrophobic matrices. Conventional labels often fail to integrate stably with hydrophobic polymers, but these hydrophobic metallic nanolabels are specifically engineered to match the hydrophobicity of the host matrix, ensuring complete and stable encapsulation. Additionally, it resolves the issue of limited stability in biological environments. Many traditional labels are prone to detachment or degradation in complex biological conditions, but these nanolabels offer enhanced stability and attachment, maintaining functionality in dynamic environments.

Another issue addressed is the lack of multifunctionality in existing labels. While conventional labels typically serve a single purpose, such as imaging or tracking, these nanolabels provide multifunctional capabilities, including particle tracking, imaging contrast, therapeutic delivery, and quantification, enabling broader applications in drug delivery, theranostics, and biosensing. Finally, the technology improves imaging and detection sensitivity. The metallic composition of the nanolabels enhances visibility and contrast in advanced imaging techniques, providing more accurate particle tracking and analysis. By addressing these issues, the technology enables more efficient, stable, and versatile solutions for applications in medicine, diagnostics, and industry.

### Details of the Invention Operation/Functions:

This invention has a wide range of current and potential future applications across several fields.

In one embodiment, the invention is used in drug delivery systems, for example, the hydrophobic metallic nanolabels can be used to enhance the tracking and monitoring of drug-loaded particles, ensuring precise delivery to targeted sites and improving drug bioavailability and efficacy.

In one embodiment, the invention is used in imaging and diagnostics, for example, the nanolabels can serve as advanced imaging contrast agents for techniques such as electron microscopy, X-ray imaging, and other imaging modalities, improving the visibility and sensitivity of nanoparticles in complex biological environments.

In one embodiment, the invention is used in theranostics, for example, these nanolabels offer the potential for integrated therapeutic and diagnostic applications, enabling simultaneous monitoring of drug delivery while also providing real-time diagnostic information, which is useful in cancer therapy, gene delivery, and other targeted treatments.

In one embodiment, the invention is used in biosensing and bioquantification, for example, the labels can be incorporated into biosensors for enhanced sensitivity and specificity in detecting analytes, providing valuable data for diagnostic applications or environmental monitoring.

In one embodiment, the invention is used in biomedical devices, for example, the nanolabels could be used for functionalizing medical implants, biosensors, or prosthetics, improving their stability and performance in biological environments.

In one embodiment, the invention is used in personalized medicine, for example, to track and control drug delivery at a molecular level, which could contribute to personalized treatment plans and optimizing drug therapies based on individual patient profiles.

In one embodiment, the invention is used in advanced materials and coatings, for example, these nanolabels could be applied in the development of advanced materials or coatings for industrial or consumer products, providing enhanced durability and functional properties such as self-healing or improved performance in harsh environments.

In one embodiment, the invention is used in agricultural applications, for example, the technology could be extended to agricultural sectors for monitoring and controlling the delivery of agrochemicals, improving crop yield and reducing environmental impact.

As the technology advances and its capabilities expand, these and other potential applications will continue to emerge, offering new opportunities across diverse industries.

The use of noble metals such as gold, silver, and platinum can make the nanolabels more expensive compared to traditional fluorescent dyes or other less costly labeling methods. This challenge can be addressed by optimizing the synthesis process to reduce material waste and increase yield, which would help lower the overall production cost. Additionally, exploring the use of metal alloys or less expensive metal composites, while maintaining the necessary functionality, could further reduce costs. Scaling up production and leveraging advanced manufacturing techniques could also create efficiencies that make the production of these nanolabels more cost-effective in the long run, making the technology more accessible for widespread applications.

### Unique Features of Invention:

This intellectual property differs from existing technologies by offering a novel approach to labeling hydrophobic polyester particles such as PLA, PLGA, and polylactones with hydrophobic metallic nanolabels. Unlike traditional fluorescent labeling techniques, which are limited by issues such as photobleaching and desorption from the core of the labeled particles, these metallic nanolabels provide enhanced stability, better compatibility with hydrophobic matrices, and superior multifunctional capabilities.

One of the main advantages of this technology is its ability to ensure stable and complete encapsulation of the nanolabels within the hydrophobic polyester matrix. This feature significantly reduces the likelihood of label detachment or degradation, a common issue with fluorescent labels, which can suffer from desorption, leading to a loss of signal over time. Additionally, unlike fluorescent dyes, which tend to degrade or lose intensity due to photobleaching when exposed to light, metallic nanolabels maintain their performance and provide consistent signals even under prolonged exposure to light, making them more reliable for long-term studies and applications.

This technology also enables high-resolution visualization using electron microscopy (EM) at spatial resolutions much higher than those achievable with fluorescence microscopy. This capability is particularly valuable in fields such as drug delivery and biomedical research, where fine structural details and precise localization of nanoparticles within cells or tissues are crucial. Furthermore, the metallic nanolabels allow for highly sensitive and selective quantification using inductively coupled plasma mass spectrometry (ICP-MS), a technique that provides greater sensitivity and specificity compared to fluorescence-based quantification methods. ICP-MS is able to detect trace amounts of metals in complex biological samples, making it an ideal method for quantifying the nanolabels with greater precision.

In addition to these advantages, the multifunctionality of these metallic nanolabels enables diverse uses, including drug delivery, theranostics, imaging, and biosensing, without the limitations associated with conventional fluorescent labels. The metallic nature of the nanolabels also improves their sensitivity in imaging applications, providing higher contrast and better detection capabilities in various imaging techniques, such as electron microscopy and X-ray imaging.

In summary, this technology overcomes many of the drawbacks of fluorescence labeling by offering superior stability, reduced risk of label loss, and enhanced multifunctionality. It provides a more robust and versatile solution for nanoparticle tracking and other applications in complex biological environments, while also enabling higher-resolution imaging and more sensitive quantification compared to traditional fluorescent labeling methods.

### BRIEF DESCRIPTION OF FIGURES

FIG. 1 Description: (1a, 1b) Synthesis of ultrasmall gold nanoparticles (usGNP) with varying concentrations of sodium borohydride (A-J), conducted without the use of a capping agent. (2) Normalized UV-Vis spectra depicting the distinct absorption peaks corresponding to each reaction condition (A-J).

FIG. 2 Description: (1a, b) Synthesis of usGNP with varied concentration of sodium borohydride (A-K) respectively, conducted with addition of sodium citrate as capping agent (2) Normalized UV-Vis spectra shows the clear absorption peaks of the respective reactions (A-K).

FIG. 3 Description: (a) Optimized ratios of usGNPs synthesized using two different methods (Method 1 and Method 2). (b) Normalized UV-Vis spectra corresponding to the optimized ratios obtained from both synthesis methods.

FIG. 4 Description: Dynamic light scattering (1a, 2a) and Zeta potential (1b, 2b) of the synthesized ultra-small gold nanoparticles, illustrating the particle size distribution and surface charge value, respectively.

FIG. 5 Description: (1a and 1b) Transmission Electron Microscopy (TEM) micrographs depicting the ultra-small gold nanoparticles synthesized using Method 1 and Method 2, respectively. (2a and 2b) Particle size analysis was performed using ImageJ software, and graph plotted.

FIG. 6 Description: Hypothetical mechanism for the synthesis of thiolated poly(lactic acid) via ring-opening polymerization.

FIG. 7 Description: Visual progression of the polymerization reaction.

FIG. 8 Description: Purified PLA precipitate.

FIG. 9 Description: Reduction process (1a) Turbid reaction mixture immediately after mixing (1b) Clear solution observed after 24 h.

FIG. 10 Description: Purified and dried thiolated poly(lactic acid) (PLA-SH) obtained.

FIG. 11 Description: Transfer of PLA-SH dispersed in chloroform into a glass vial for solvent removal. (b) Dried PLA-SH weighed and prepared for subsequent characterization.

FIG. 12 Description: MALDI-TOF mass spectra of thiolated poly(lactic acid) (PLA-SH), showing the molecular weight distribution and confirming successful synthesis.

FIG. 13 Description: Characterization of PLA-SH (a) Proton nuclear magnetic resonance (¹H-NMR) spectra (b) Carbon nuclear magnetic resonance (¹³C-NMR) spectra.

FIG. 14 Description: Fourier transform infrared spectroscopy (FTIR) graph showing molecular structure of synthesized PLA-SH with key functional groups.

FIG. 15 Description: (A) Ultra-small gold nanoparticles (usGNPs) synthesized via Method 1 and Method 2; (B) Addition of usGNPs to dichloromethane (DCM) containing PLA-SH for surface functionalization; (C) Phase transfer of PLA-SH functionalized usGNPs from the aqueous phase to the organic phase; (D) UV-Vis absorption spectra comparing usGNPs and PLA-SH-usGNPs from M-1, M-2.

FIG. 16 Description: Characterization of usGNP and usGNP-PLA-SH respectively (1a, 2a) DLS size analysis (1b, 2b) TEM analysis (1c, 2c) ImageJ analysis.

FIG. 17 Description: (a) Synthesized PLA-SH; (b) usGNPs synthesized without a capping agent; (c) Surface functionalization of usGNPs with PLA-SH; (d) Dispersion of PLA-SH-usGNPs in acetone and stored at −20° C.

FIG. 18 Description: (a) Stock solution of PLA-usGNP in acetone, (b) Purified PLA-usGNP after centrifugation and acetone wash, (c) PLGA solution mixed with the purified PLA-usGNP.

FIG. 19 Description: (a) Blue and white layered precipitate with a clear supernatant obtained after centrifugation; (b) PLA-usGNP-PLGA precipitate resulting from centrifugation; (c) Collection of PLA-usGNP-labeled PLGA nanoparticles in water.

Illustrative embodiments of the present invention are described in detail below with reference to the attached drawing figures, which are incorporated by reference herein.

### DETAILED DESCRIPTION

Described herein are hydrophobic metallic nanolabels composed of noble metals (such as gold, silver, platinum, or their composites) specifically engineered to label hydrophobic polyester particles like PLA, PLGA, and polylactones. These nanolabels exhibit unique hydrophobic properties that ensure stable encapsulation within the host matrix, a feature not commonly found in existing labeling technologies. This is a new material with multifunctional applications in drug delivery, diagnostics, imaging, and theranostics. In other embodiments, these nanolablels offer potential improvements to existing processes for nanoparticle functionalization and labeling.

In one embodiment, described herein is a polymer composite comprising a plurality of surface functionalized metallic nanoparticles encapsulated in polyester particles, wherein the metallic nanoparticles are functionalized with thiolated polylactic acid (PLA) or poly(lactic-co-glycolic acid) (PLGA). In one embodiment, the core of the nanoparticle (the nanoparticle excluding the thiolated polylactic acid (PLA) or poly(lactic-co-glycolic acid) (PLGA)) is less than 10 nm in diameter.

In one embodiment, the nanoparticles are gold nanoparticles, silver nanoparticles, platinum nanoparticles, or nanoparticles comprising a composite of gold, silver, or platinum. In one embodiment, the nanoparticles are gold nanoparticles. In one embodiment, the nanoparticles are silver nanoparticles. In one embodiment, the nanoparticles are platinum nanoparticles. In one embodiment, the nanoparticles are a composite of gold and silver, a composite of gold and platinum, or a composite of gold, silver, and platinum.

In one embodiment, the nanoparticles are functionalized with thiolated polylactic acid (PLA). In one embodiment, the nanoparticles are functionalized with thiolated poly(lactic-co-glycolic acid) (PLGA). Alternatively, the nanoparticles can be functionalized with any hydrophobic polymer, including, but not limited to polyethylene, polypropylene, and polystyrene.

In one embodiment, the nanoparticles are functionalized with thiolated PLA and the molecular weight of the PLA is between about 1,000 g/mol and 10,000 g/mol. In one embodiment, the nanoparticles are functionalized with thiolated PLA and the molecular weight of the PLA is between about 1,700 g/mol and 5,000 g/mol. In one embodiment, the nanoparticles are functionalized with thiolated PLA and the molecular weight of the PLA is between about 1,700 g/mol and 2,500 g/mol. In one embodiment, the nanoparticles are functionalized with thiolated PLA and the molecular weight of the PLA is between about 2,500 g/mol and 5,000 g/mol.

In one embodiment, the nanoparticles are functionalized with thiolated PLGA and the molecular weight of the PLA is between about 1,000 g/mol and 10,000 g/mol. In one embodiment, the nanoparticles are functionalized with thiolated PLGA and the molecular weight of the PLA is between about 1,700 g/mol and 5,000 g/mol. In one embodiment, the nanoparticles are functionalized with thiolated PLGA and the molecular weight of the PLA is between about 1,700 g/mol and 2,500 g/mol. In one embodiment, the nanoparticles are functionalized with thiolated PLGA and the molecular weight of the PLA is between about 2,500 g/mol and 5,000 g/mol.

In one embodiment, the core of the nanoparticles is 9 nm or less in diameter excluding the thiolated PLA or PLGA. In one embodiment, the core of the nanoparticles is 8 nm or less in diameter excluding the thiolated PLA or PLGA. In one embodiment, the core of the nanoparticles is 7 nm or less in diameter excluding the thiolated PLA or PLGA. In one embodiment, the core of the nanoparticles is 6 nm or less in diameter excluding the thiolated PLA or PLGA. In one embodiment, the core of the nanoparticles is about 5 nm in diameter excluding the thiolated PLA or PLGA. In one embodiment, the core of the nanoparticles is 5 nm or less in diameter excluding the thiolated PLA or PLGA. In one embodiment, the core of the nanoparticles is 4, 3, 2, or 1 nm in diameter excluding the thiolated PLA or PLGA.

In one embodiment, the nanoparticles are less than 30 nm including the thiolated PLA or PLGA. In one embodiment, the nanoparticles are less than 22 nm including the thiolated PLA or PLGA. In one embodiment, the nanoparticles are less than 30 nm including the thiolated PLA or PLGA. In one embodiment, the nanoparticles are less than 20 nm including the thiolated PLA or PLGA. In one embodiment, the nanoparticles are less than 15 nm including the thiolated PLA or PLGA. In one embodiment, the nanoparticles are about 22 nm including the thiolated PLA or PLGA.

In one embodiment, the polyester particles comprise polylactic acid (PLA), poly(lactic-co-glycolic acid) (PLGA), or polylactone. In one embodiment, the polyester particles comprise polylactic acid (PLA). In one embodiment, the polyester particles poly(lactic-co-glycolic acid) (PLGA). In one embodiment, the polyester particles comprise polylactone.

In one embodiment, the polymer composite comprises a plurality of surface thiolated polylactic acid (PLA) functionalized gold nanoparticles encapsulated in poly(lactic-co-glycolic acid) (PLGA) particles, wherein the gold nanoparticles 5 nm or less in diameter excluding the thiolated polylactic acid (PLA).

Also described herein is a method of preparing a polymer composite comprising a plurality of surface functionalized metallic nanoparticles encapsulated in polyester particles, wherein the metallic nanoparticles are functionalized with thiolated polylactic acid (PLA) or poly(lactic-co-glycolic acid) (PLGA) and the nanoparticles are less than 10 nm in diameter excluding the thiolated polylactic acid (PLA) or poly(lactic-co-glycolic acid) (PLGA), comprising steps (a)-(d):
a. Synthesizing the metallic nanoparticles;
b. Synthesizing thiolated poly(lactic acid) (PLA-SH) or poly(lactic-co-glycolic acid) (PLGA-SH);
c. Surface-functionalizing the nanoparticles with the PLA-SH or PLGA-SH to afford nanoparticles functionalized with PLA-SH or PLGA-SH; and
d. Encapsulating the gold nanoparticles functionalized with PLA-SH or PLGA-SH in polyester nanoparticles via nanoprecipitation to afford the polymer composite

In one embodiment, the method of preparing the polymer composite, comprising steps (a)-(d):
a. Mixing chloroauric acid (HAucl₄) with sodium borohydride to afford gold nanoparticles;
b. Conducting ring opening copolymerization of lactide in the presence of 2-hydroxyethyl disulfide and stannous octoate and subsequent reduction in the presence of DL-dithiothreitol to afford thiolated poly(lactic acid) (PLA-SH);
c. Surface-functionalizing the gold nanoparticles with the PLA-SH via the phase transfer method to afford gold nanoparticles functionalized with PLA-SH; and
d. Encapsulating the gold nanoparticles functionalized with PLA-SH in poly(lactic-co-glycolic acid) (PLGA) nanoparticles via nanoprecipitation to afford the polymer composite.

In one embodiment, step (a) further comprises mixing HAucl₄ with sodium citrate. In one embodiment, step (a) further comprises mixing HAucl₄ with sodium citrate. In one embodiment, the gold nanoparticles of step (a) are 10 nm or less in diameter. In one embodiment, the gold nanoparticles of step (a) are 9 nm or less in diameter. In one embodiment, the gold nanoparticles of step (a) are 8 nm or less in diameter. In one embodiment, the gold nanoparticles of step (a) are 7 nm or less in diameter. In one embodiment, the gold nanoparticles of step (a) are 6 nm or less in diameter. In one embodiment, the gold nanoparticles of step (a) are 5 nm in diameter. In one embodiment, the gold nanoparticles of step (a) are 5 nm or less in diameter. In one embodiment, the gold nanoparticles of step (a) are 4, 3, 2, or 1 nm in diameter.

In one embodiment, in step (c), the phase transfer method is conducted in the presence of water and methanol. In one embodiment, step (d) comprises step (d.1): adding PLGA to the gold nanoparticles functionalized with PLA-SH in acetone and allowing the mixture to stir and step (d.2): adding the mixture from step (d.1) dropwise to water with stirring to form the polymer composite.

### EXAMPLES

Fabrication & Characterization of usGNP

Gold nanoparticles (GNPs) can be synthesized using a variety of methods, each providing distinct levels of control over their size, shape, and surface properties [22]. Among these, the wet chemistry method, also known as the chemical reduction method, is one of the most widely used approaches. This method involves the reduction of Au³⁺ ions in solution, typically by using a reducing agent such as sodium borohydride or citrate, which leads to the formation of metallic gold nanoparticles [23]. Here, optimizing the synthesis of usGNP is crucial for achieving high stability and minimal particle size. The synthesis of usGNP requires precise control over key factors, including the reducing agent, capping agent, and stabilizing agent, which directly influence the properties of the resulting nanoparticles [24]. To determine the optimal conditions, a series of distinct methodologies were developed, each utilizing different combinations of these agents. Characterization of the synthesized nanoparticles, including size, colloidal stability, and morphology guides the selection of the most effective method and reagent ratios.

Synthesis of usGNP with No Capping Agent

The synthesis of smaller size and uncapped gold nanoparticles is critical, particularly for the surface functionalization of usGNP. The absence of a capping agent on the usGNP facilitates direct conjugation to the desired ligands. Therefore, in this study, “naked” usGNPs were synthesized without the use of a capping agent, relying solely on sodium borohydride (NaBH₄) as the reducing agent.

In this method, usGNPs were synthesized without using stabilizing or capping agents. Optimization was carried out by systematically increasing the ratio of sodium borohydride to hydrochloroauric acid (HAuCl₄) solution. The resulting nanoparticle size, stability, and characteristics were monitored to determine the optimal reducing agent concentration to produce the stable and uncapped usGNPs.

TABLE 1
Optimization of NaBH₄

| | Volume (in mL) | | | | | | | | | |
|---|---|---|---|---|---|---|---|---|---|---|
| | A | B | C | D | E | F | G | H | I | J |
| 50 mM | 0.1 | 0.1 | 0.1 | 0.1 | 0.1 | 0.1 | 0.1 | 0.1 | 0.1 | 0.1 |
| HAucl₄ | | | | | | | | | | |
| 50 mM | 0.1 | 0.2 | 0.3 | 0.4 | 0.5 | 0.6 | 0.7 | 0.8 | 0.9 | 1.0 |
| NaBH₄ | | | | | | | | | | |
| Milli-Q | 9.8 | 9.7 | 9.6 | 9.5 | 9.4 | 9.3 | 9.2 | 9.1 | 9.0 | 8.9 |
| water | | | | | | | | | | |

Allowed to mix for 1 min

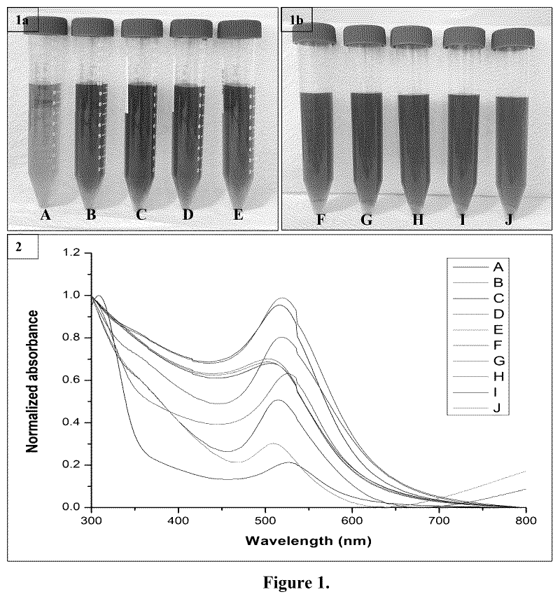

The samples (A to J) prepared at different concentrations, were visibly checked for aggregation. Then all of the samples were analyzed using UV-Vis spectroscopy to assess their optical properties. The nanoparticle solutions synthesized exhibit varied surface plasmon resonance (SPR) effects, with no observable aggregation in any of the tubes (FIG. 1).

The UV-Vis spectra revealed absorption peaks between 510-515 nm, corresponding to the Surface Plasmon Resonance (SPR), a characteristic feature of GNPs. This specific wavelength provides critical information regarding the size, shape, and concentration of the nanoparticles in the solution. The presence of this SPR peak confirms that the particles successfully exhibit plasmonic behavior, which is typical for GNPs and crucial for their optical and electronic properties.

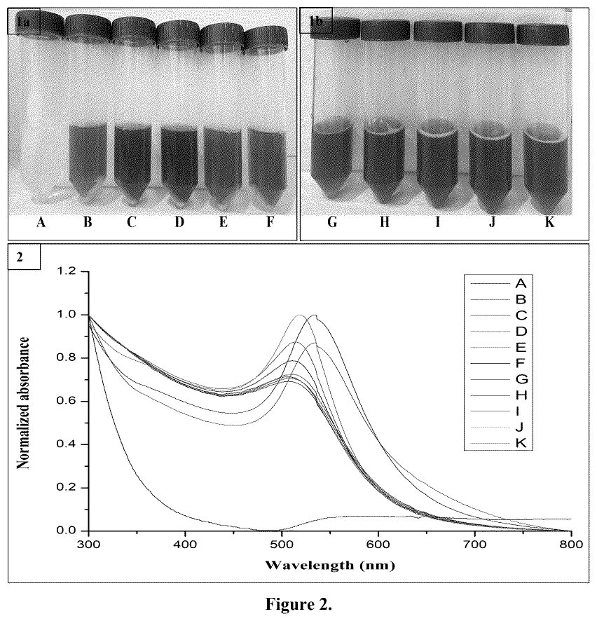

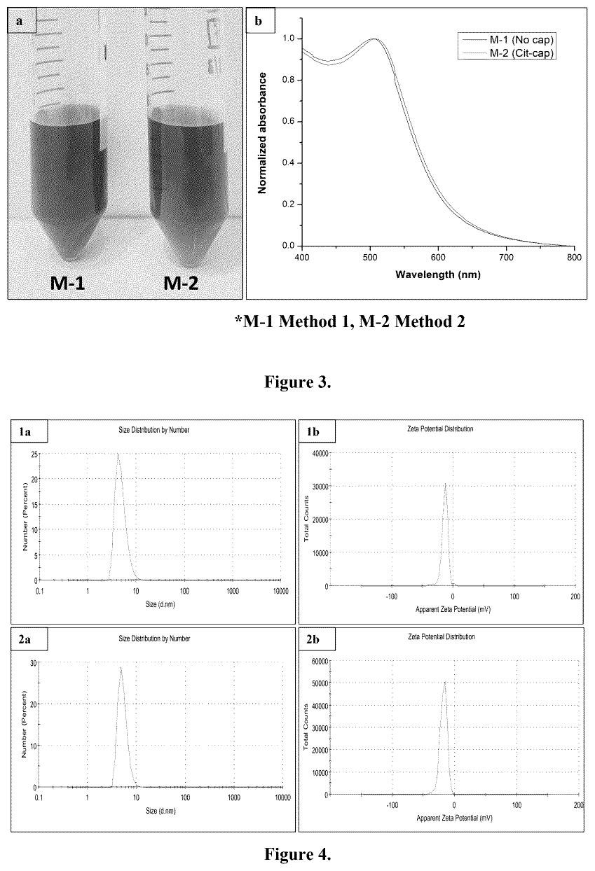

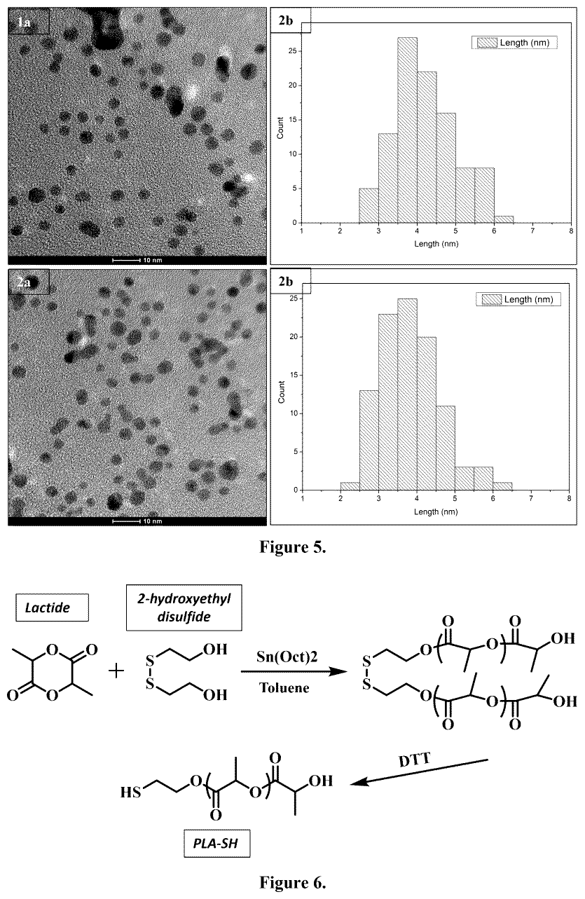

The colors observed in samples A and B (FIG. 1a) correspond to SPR peaks at 526-528 nm in the UV-Vis spectra (FIG. 2). In this region, the SPR wavelength typically reflects particles of around 10-30 nm in diameter. The narrow wavelength range suggests the nanoparticle size and morphology remaining relatively consistent, with a minimal aggregation. The color is likely reddish-pink, which is typical for GNPs in this size range, where the SPR peak is centered near these wavelengths. The SPR peaks for samples C to E, appearing between 504 and 508 nm, indicate the presence of smaller GNPs compared to the samples A and B. This blue shift in the wavelength suggests a reduction in particle size, as smaller nanoparticles exhibit SPR peaks at shorter wavelengths due to more confined surface electron oscillations [25]. The formation of smaller particles in samples C to E could be due to more effective reduction by sodium borohydride, resulting in faster nucleation and the generation of smaller gold nanoparticles, which absorb light at higher energy (shorter wavelengths).

The SPR peaks for samples F to J, appearing between 515 and 520 nm, indicate a slight redshift compared to samples C to E. This suggests an increase in the size of the gold nanoparticles or the onset of slight aggregation. Larger nanoparticles or aggregated particles exhibit SPR peaks at longer wavelengths due to less confined electron oscillations. The shift in this range could be caused by a decrease in sodium borohydride's reducing efficiency at higher concentrations, leading to slower nucleation, which allows more growth of individual nanoparticles or mild particle clustering [26]. Consequently, this results in a shift back toward longer wavelength.

Synthesis of usGNP with Sodium Citrate

In this approach, usGNPs were synthesized with the addition of sodium citrate as a stabilizing or capping agent. Optimization involved systematically varying the reducing agent sodium borohydride to HAuCl₄ ratio. The resulting nanoparticle size, stability, and physicochemical properties were analyzed to identify the optimal reducing agent concentration required to synthesize the stable, citrate-capped GNPs.

TABLE 2
Optimization of NaBH₄ for usGNP synthesis

| | Volume (in mL) | | | | | | | | | | |
|---|---|---|---|---|---|---|---|---|---|---|---|
| | A | B | C | D | E | F | G | H | I | J | K |
| 10 mM | 0.5 | 0.5 | 0.5 | 0.5 | 0.5 | 0.5 | 0.5 | 0.5 | 0.5 | 0.5 | 0.5 |
| HAucl₄ | | | | | | | | | | | |
| 10 mM | 0.5 | 0.5 | 0.5 | 0.5 | 0.5 | 0.5 | 0.5 | 0.5 | 0.5 | 0.5 | 0.5 |
| Sodium | | | | | | | | | | | |
| citrate | | | | | | | | | | | |
| Milli-Q | 19.0 | 18.8 | 18.6 | 18.4 | 18.2 | 18.0 | 17.8 | 17.6 | 17.4 | 17.2 | 17.0 |
| water | | | | | | | | | | | |
| 50 mM | 0.0 | 0.2 | 0.4 | 0.6 | 0.8 | 1.0 | 1.2 | 1.4 | 1.6 | 1.8 | 2.0 |
| NaBH₄ | | | | | | | | | | | |

Allowed to mix

The samples, prepared at different concentrations, were analyzed using UV-Vis's spectroscopy to assess their optical properties. The nanoparticle solutions synthesized exhibited varied SPR effects, with no observable aggregation in all of the tubes (FIG. 2).

The color variations in FIG. 1a, b, and the UV-Vis spectra explains the changes in the size and aggregation state of the gold nanoparticles as sodium borohydride was gradually added with a constant amount of sodium citrate. In samples B to C, the violet color corresponds to a redshift in the SPR peak to 533-535 nm (FIG. 2), indicating larger or more aggregated nanoparticles. Larger particles have less confined electron oscillations that absorbs light at longer wavelengths and hence led to the shift to this range and the observed color. Similarly, starting with sample D (518-519 nm) and continuing with samples E (513-516 nm) and F to K (509-514 nm), there was a progressive blue shift. This reflects a decrease in nanoparticle size as sodium borohydride concentration increases. Sodium borohydride is a stronger reducing agent, and its gradual addition leads to faster nucleation and the formation of smaller nanoparticles. Smaller particles absorb light at shorter wavelengths (higher energy), resulting in the blue shift observed across these samples [25]. Sodium citrate acts as a stabilizer, maintaining dispersion and preventing aggregation, which contributes to the formation of smaller particles as sodium borohydride concentration increases.

Method Optimization for usGNP Synthesis and Characterization

From the two synthesis methods for usGNPs, the nanoparticle solutions were evaluated based on visible color changes and corresponding UV-Vis spectra. Dynamic light scattering (DLS) size analysis and zeta potential measurements were performed for all reactions. Based on these data, two reactions were selected as the optimized ratios, yielding stable nanoparticle solutions with no aggregation, and exhibiting SPR effects consistent with usGNP, with core diameters of less than 5 nm. These two reactions were subsequently repeated, followed by further analysis to determine particle size, shape, and morphology.

TABLE 3
Characterization of Optimized usGNP synthesized from both methods

| | | | | | Maximum |
|---|---|---|---|---|---|
| | Particle size | | Zeta | TEM/ImageJ- | wavelength of |
| Method/Sample | (Hydrodynamic | Polydispersity | potential | size analysis | the plasmon |
| No | diameter, nm) | index | (mV) | (nm) | peak (nm) |
| Method 1 | 5.05 ± 0.28 | 0.38 ± 0.04 | −13.3 ± 0.57 | 4.20 ± 0.80 | 507 |
| (Sample D) | | | | | |
| Method 2 | 5.30 ± 0.09 | 0.32 ± 0.14 | −16.9 ± 1.41 | 3.83 ± 0.76 | 509 |
| (Sample F) | | | | | |

The average hydrodynamic diameter, polydispersity index (PDI), and zeta potential of the optimized ratios of ultra-small gold nanoparticles (usGNPs) from both synthesis methods were measured using dynamic light scattering (DLS) on a Zetasizer Nano ZS (Malvern Instruments Ltd., Malvern, UK). All measurements were performed in triplicate, and the results are reported as mean values (Table 5).

DLS is commonly used to measure the hydrodynamic diameter of nanoparticles, including GNPs. The data obtained from the analysis indicate that both synthesis methods successfully produced usGNPs with the average core diameter of 5 nm. These usGNPs are particularly valuable due to their unique optical and chemical properties, such as enhanced SPR effects, beneficial for biomedical imaging and photothermal therapy. Their high surface area-to-volume ratio enhances molecular interactions, increasing active sites for catalytic reactions and improving functionalization with drugs or targeting ligands [27]. This smaller size also promotes cellular uptake and renal clearance, reducing the long-term toxicity [28]. The low polydispersity index (PDI), less than 0.5, suggests a narrow size distribution and uniformity in particle size within the sample. A PDI below 0.5 is generally considered indicative of monodispersity, which is essential for reproducibility and stability in applications [29]. The combination of smaller size and low PDI promotes unique functional properties of usGNPs ideal for various applications.

The zeta potential reflects the surface charge and stability of the nanoparticles. usGNPs from method 1 show a zeta potential of −13.3 mV, indicating moderate colloidal stability due to the absence of a stabilizing agent. However, the negative charge still provides electrostatic repulsion, preventing aggregation. In contrast, usGNPs from method 2 exhibit a zeta potential of
—16.9 mV, indicating improved stability. Sodium citrate, acting as both a reducing and capping agent, increases the surface charge, enhancing electrostatic stabilization [24]. This explains as the zeta potential values of usGNPs from both methods are adequate to maintain the nanoparticle dispersion and prevent aggregation.

Transmission electron microscopy (TEM) coupled with ImageJ software analysis provides detailed insights into the morphology and size distribution of usGNPs. The results from method 1 yielded an average particle size of 4.20±0.80 nm, while method 2 resulted in an average size of 3.83±0.76 nm. TEM offers high-resolution images that facilitate the study of morphology and precise measurement of individual nanoparticle dimensions, enabling accurate characterization of size distribution. The morphology of GNPs varies based on the synthesis method, with spherical GNPs being the most commonly studied due to their isotropic properties, which enhance their behavior in solution. Notably, spherical nanoparticles exhibit higher cellular internalization compared to larger or irregularly shaped particles, thereby improving their effectiveness in drug delivery systems [30].

A narrow size distribution is crucial for ensuring uniform behavior and performance, as it enhances catalytic efficiency by providing consistent surface area and active sites for reactions. The spatial distribution of nanoparticles in biological systems is influenced by size and morphology, with smaller nanoparticles (approximately 4-5 nm) being more suitable for penetrating biological membranes and accumulating in tissues effectively. Both TEM and ImageJ software reveal the size, shape, and distribution of usGNPs, providing critical information on their optical, electronic, and catalytic properties [31]. Controlled synthesis methods yielding spherical nanoparticles with narrow size distributions are essential for maximizing performance, particularly in surface functionalization. An advantage of method 1 is its ability to produce “naked” gold nanoparticles without capping agents, facilitating surface functionalization with thiol groups from polymers and enhancing binding efficiency for further applications [32].

### Synthesis of PLA-SH Via Ring-Opening Co-Polymerization and Characterization

A ring-opening copolymerization (ROP) protocol to synthesize thiolated poly(lactic acid) (PLA-SH) with varying lactide-to-glycolide ratios as illustrated was developed and optimized.

### Polymerization

In the synthesis of thiolated poly(lactic acid) (PLA-SH) via ring-opening copolymerization, 2-hydroxyethyl disulfide (104.5 mg, 0.677 mmol), stannous octoate (Sn(Oct)₂) (49.3 mg, 0.122 mmol), and lactide (5.394 g, 37.38 mmol) were combined in a 25 mL round-bottom flask. 2-Hydroxyethyl disulfide served as the initiator, introducing thiol groups, while stannous octoate acted as the catalyst to facilitate the polymerization. Toluene (20 mL) was then added as a solvent to dissolve the reactants, followed by stirring at 600 rpm to ensure thorough mixing. The flask was purged with nitrogen gas for 20 minutes to remove oxygen and moisture, creating an inert atmosphere required for controlled polymerization. After sealing the flask, the reaction mixture was allowed for mixing at 300 rpm at 100° C. for 24 h, enabling the ring-opening polymerization of lactide and formation of the polymer. Vigorous stirring was maintained throughout to promote uniform distribution of reactants, optimizing the polymerization process.

TABLE 4
Polymerization

| | Volume | |
|---|---|---|
| 2-Hydroxyethyl disulfide | 83 | μl |
| Sn(Oct)₂ - (Tin(II) 2- | 39 | μl |
| ethylhexanoate) | | |
| Lactide | 5.394 | g |
| Toluene | 20 | ml |

Mixture was allowed to stir at 300 rpm at 100° C./24 h

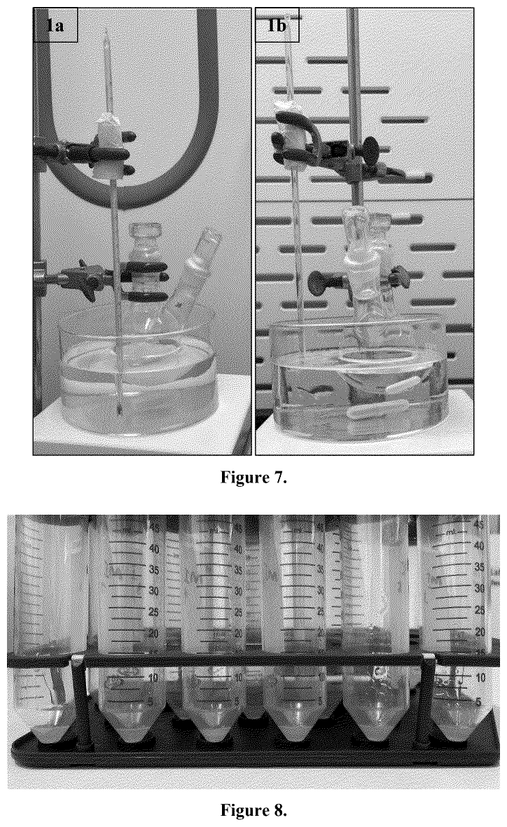

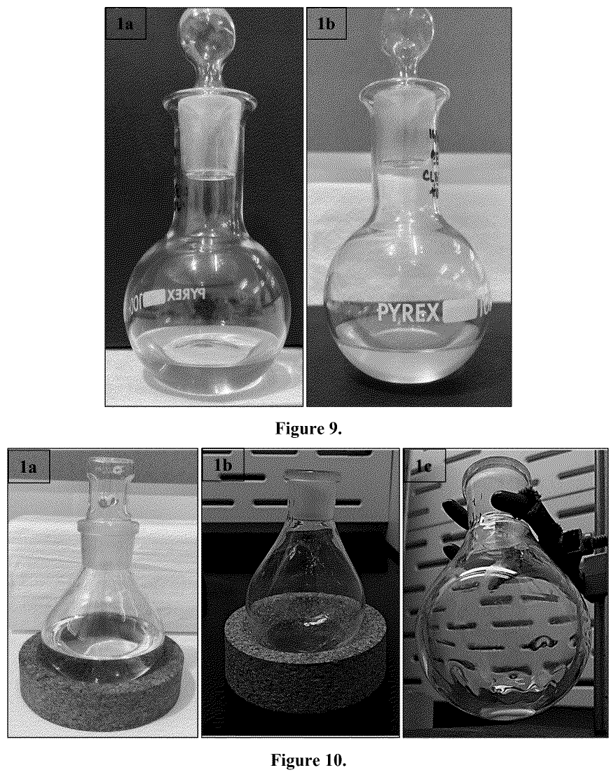

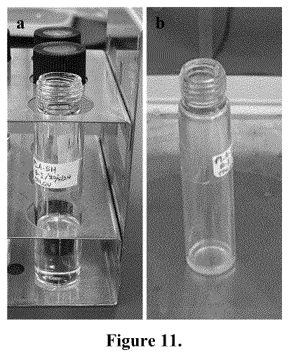

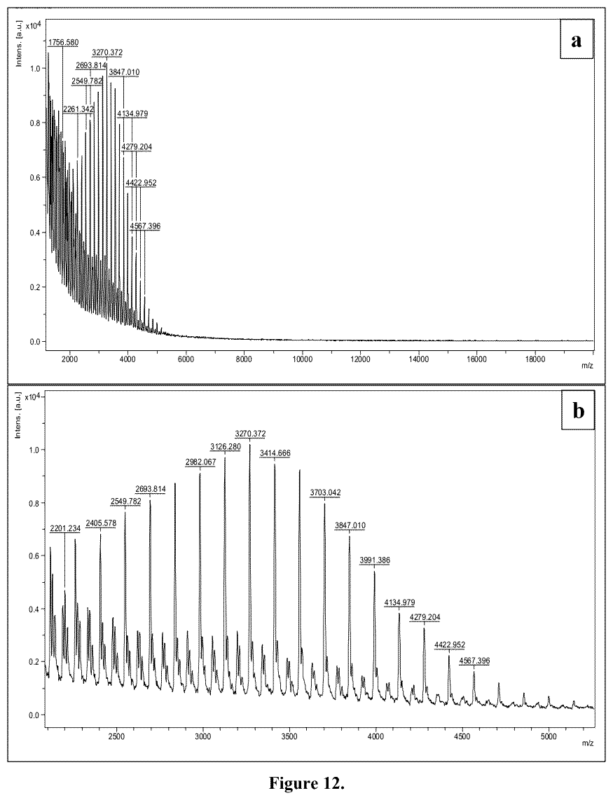

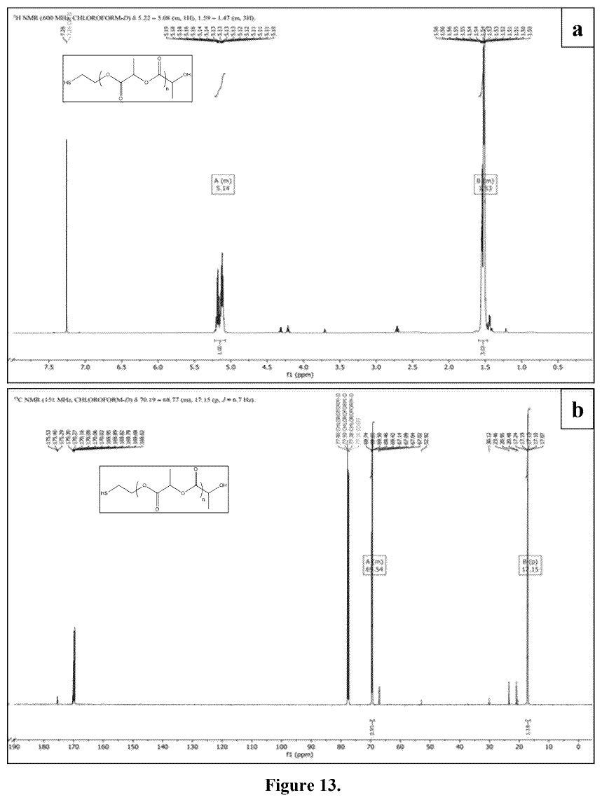

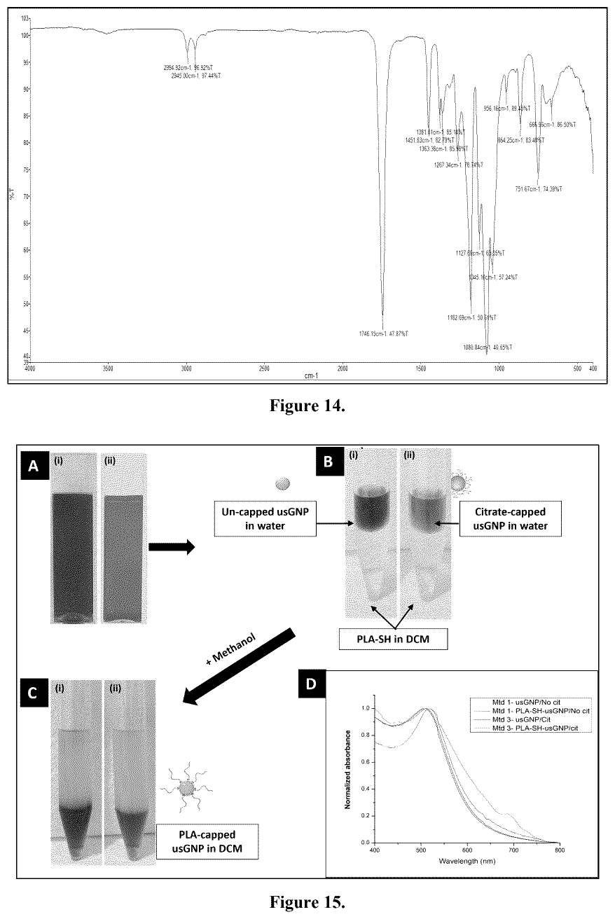

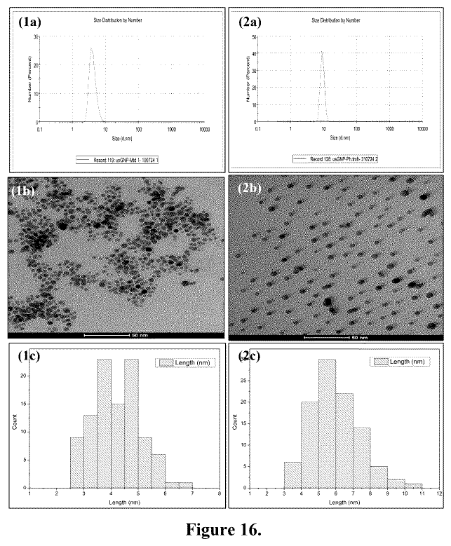

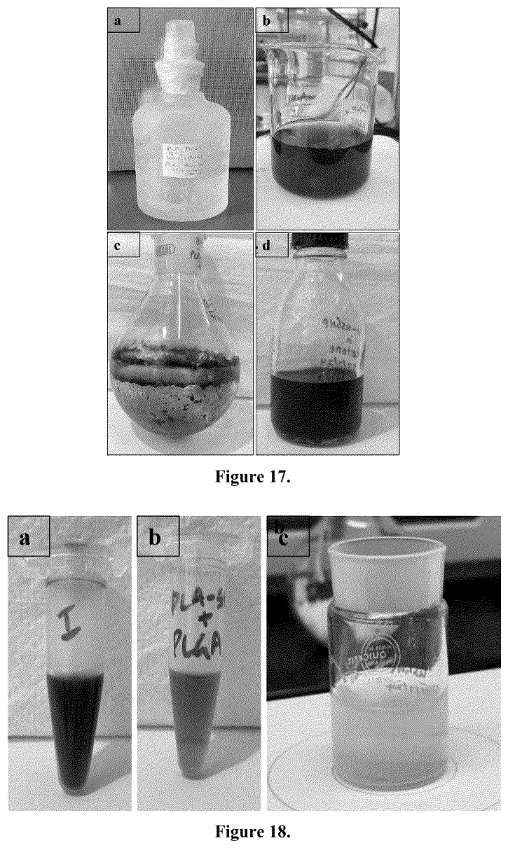

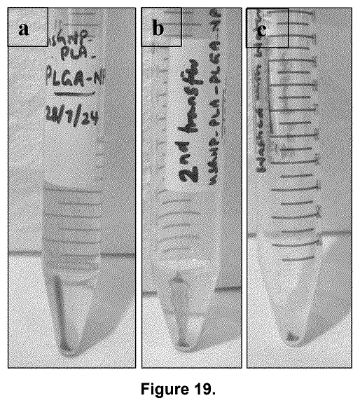

The progression of the polymerization reaction was monitored by observing the visual appearance of the solution. Initially, the mixture was insoluble and displayed a milky appearance, but over time, it gradually transitioned through various stages. At first, the solution became cloudy, then turbid, and eventually progressed to a mild to slightly turbid state. As the reaction continued, the turbidity decreased, and the solution exhibited slight clarity. By the later stages of the reaction, the mixture was nearly transparent. By the following day, the mixture was observed to be completely clear and transparent. This color change from turbid to clear indicated the successful progress of the polymerization and the dissolution of the reactants in the round-bottom flask, indicating the formation of the polymer (FIG. 7).

### Purification

The synthesized PLA mixture was added dropwise into 250 mL of methanol, which acted as a non-solvent, facilitating the precipitation of the polymer. This careful addition promoted uniform nucleation and subsequent gel-like precipitation. Following the dropwise addition, the mixture was subjected to centrifugation at 9,000 rpm for 3 mins to facilitate the separation of the precipitated gel from the supernatant. The gel-like precipitate was collected and subsequently dissolved in 20 mL of chloroform to ensure complete solubilization of the polymer. This chloroform solution was then re-precipitated in methanol to further purify the PLA by removing any residual impurities or unreacted monomers. This two-step precipitation process with methanol and dissolving in chloroform ensured a higher purity of the product obtain.

To the precipitate obtained in each tube, 7.5 mL of methanol was added to facilitate further purification. The tubes were then placed in a sonicator bath for degassing for 10 mins. After sonication, some tubes remained unchanged while others turned turbid, indicating partial dissolution. Following this, all of the tubes were centrifuged at 9,000 rpm for 4 mins to obtain the precipitate. The polymer samples, left as a gel-like precipitate after centrifugation, were placed in the vacuum drying oven under vacuum conditions (VWR 1470-2) at 13.6 mbar, 35° C. for 45 to 60 minutes. This step ensured the complete evaporation of residual methanol, leaving behind a dry polymer product, which was further taken for further processing.

### Reduction

For the reduction step, the purified PLA polymer was first dissolved in 20 mL of chloroform, creating a homogeneous solution that facilitated the subsequent reaction. To this solution, DL-dithiothreitol (DTT) was added at a concentration of 1.07 g (6.94 mmol). DTT, a reducing agent, was selected for its ability to cleave disulfide bonds effectively, thereby transforming the thiol-functionalized polymer into a more reactive form. To enhance the reduction process, two drops of triethylamine were introduced as a catalyst, which serves to accelerate the reaction kinetics by facilitating the deprotonation of thiol groups.

TABLE 5
Reduction

| | Volume | |
|---|---|---|
| Purified polymer precipitate | Complete | |
| Chloroform | 20 | ml |
| DL-dithiothreitol (DTT) | 1.07 | g |
| Triethylamine | 2 | drops |

Mixture was allowed to react overnight at 24 ± 1° C.

The reaction mixture was then allowed to react overnight under inert conditions to ensure complete reduction of the disulfide bonds. The color of the reaction mixture changed from slightly turbid and hazy to clear after 48 hours of incubation. This change indicated a successful reduction of disulfide bonds and the dissolution of the aggregated polymer chains, reflecting the formation of a more homogeneous and stable solution. This transformation indicates the effective reaction kinetics and explains the occurrence of the desired chemical modifications, which further confirms the progression of the synthesis process. This extended reaction period was crucial for achieving reduction process, resulting in a polymer structure enriched with free thiol groups, which are essential for further functionalization.

### Purification and Estimation of PLA-SH Yield

Following the reduction of the polymer precursor, the purification process was carried out to facilitate the removal of residual dithiothreitol (DTT) and triethylamine. Chloroform (40 mL) was added to the previously obtained 20 mL chloroform mixture from reduction process and mixed thoroughly to ensure uniformity. This mixture was then transferred into a separation flask. An equal volume of 1% hydrochloric acid (HCl) was added and mixed vigorously, to form two distinct layers showing the lower layer with the polymer dissolved in chloroform, while the upper layer contained HCl solution, with a white fluffy precipitate observed between the two layers. The lower layer was transferred into a clean beaker, while the upper layer and fluffy precipitate were set aside for further analysis. The separation flask was rinsed with methanol to remove any remaining residues, and the collected lower layer was transferred back into the flask. To which, equal volume of Milli-Q water was added. This mixture was mixed by vigorous shaking to form two layers, with the lower layer containing the polymer in chloroform. The upper layer and fluffy precipitate were collected in another container. The polymer mixture was taken further for purification by repeating the washing step with 1% HCl, followed by the collection of the lower layer, which was further washed twice with Milli-Q water to ensure thorough purification.

A clean round-bottom flask purged with nitrogen gas (N2) to create an inert atmosphere, was thoroughly dried, and weight measured was kept ready for accurate yield calculation of the polymer obtain. The clear polymer mixture after repeated washing, free of DTT and triethylamine, was transferred to the clean, pre-weighed, dry round-bottom flask and subjected to rotary evaporation (Rotavapor) to eliminate any residual chloroform. This systematic purification process effectively removed unwanted impurities and solvents, yielding a high-quality polymer suitable for further characterization and application.

The rotary evaporation was conducted under controlled conditions, specifically set to a low pressure of 132 mbar, with a rotation speed of 130 rpm, a vapor temperature of 23° C., and a water bath temperature of 37° C. These parameters were optimized to facilitate the efficient removal of chloroform while minimizing the risk of thermal degradation of the polymer, leading to the complete evaporation of chloroform, as indicated by the absence of liquid in the round-bottom flask. This gave rise to a thin, transparent polymer film to be observed in the round bottom flask. The flask was left open inside biosafety cabinet to ensure the complete removal of any residual solvent. After complete drying, the weight of the round-bottom flask containing the purified PLA-SH polymer was measured, providing a quantifiable yield of the synthesis process. The calculation of the yield of PLA-SH from 5 g of lactide was performed as follows:

$$Yield ( \% ) = \frac{Weight of Polymer obtained}{Weight of Monomer used} \times 100$$

$$Yield ( \% ) = \frac{2.4241}{5} \times 100 = 48.48 \%$$

TABLE 6
Yield % of Purified PLA-SH

| Product | Weight |
|---|---|
| Lactide (Monomer)- Used | 5 g |
| PLA-SH (Polymer)- Obtained | 2.42 g |
| Yield | 48.48% |

The purified thiolated polymer (PLA-SH) was then carried out for further characterization, including analysis of its molecular weight, physical and chemical properties, which are essential for assessing its suitability for intended applications.

### Characterization

The dried PLA-SH was re-dispersed in chloroform and stored at −20° C. Subsequently, the PLA-SH was characterized for nuclear magnetic resonance spectroscopy (¹H-NMR, ¹³C-NMR), Fourier-transform infrared spectroscopy (FTIR), and mass spectrometry (MS) to elucidate its structure and determine the molecular weight.

### MALDI-TOF/MS Analysis

MALDI-TOF/MS (Matrix-Assisted Laser Desorption/Ionization-Time of Flight Mass Spectrometry) is a powerful analytical technique used to determine the mass-to-charge ratio (m/z) of biomolecules such as proteins, peptides, and polymers. In this method, the sample is co-crystallized with a matrix that absorbs laser energy, facilitating the ionization of the sample molecules. The ionized molecules are accelerated through a drift region, and their time of flight is measured to calculate their m/z. This technique is widely used in proteomics, polymer characterization, and microbial identification due to its high sensitivity, ability to analyze large molecules, and minimal sample preparation requirements [33]. Here, this technique was used to analyze the synthesized PLA-SH to determine its molecular weight and detect modifications such as thiol groups.

The MALDI-TOF/MS spectrum provided showed a range of peaks corresponding to different mass-to-charge (m/z) ratios, with labeled peaks at various intensities. MALDI-TOF MS analysis of the PLA-SH polymer revealed distinct peaks across the m/z range from 1756.580 to 4567, corresponding to different molecular fragments or ionized species of the modified polymer. The presence of peaks in the lower m/z range (~1756 to 2261) likely represents smaller thiolated fragments or lower molecular weight PLA chains, which may ionize more efficiently due to their smaller size or the presence of thiol groups that enhance ionization.

In the higher m/z range (3270 to 4567), the peaks correspond to larger molecular weight species, likely representing longer PLA chains or more complex thiolated structures. These peaks show slightly lower intensity, which is characteristic of larger polymer species that tend to ionize less efficiently in MALDI-TOF MS. The presence of a broader distribution of m/z values suggests the successful incorporation of thiol groups into the PLA polymer, with varying degrees of polymerization or thiolation. The gradual reduction in intensity as the m/z increases reflects the expected lower abundance and reduced ionization efficiency of the higher molecular weight thiolated PLA species. This trend is typical for MALDI-TOF spectra of polymers, where lower molecular weight fragments dominate the signal due to easier ionization.

### Nuclear Magnetic Resonance Spectroscopy (NMR)

Nuclear Magnetic Resonance (NMR) Spectroscopy serves as an essential analytical technique used to characterize the molecular structure of polymers, including PLA-SH. Through the application of both proton (H-NMR) and carbon (C-NMR) spectroscopy, detailed insights into the chemical environment of PLA-SH can be obtained. The H-NMR spectrum allows for the identification of proton signals associated with the thiol functional groups and the polymer backbone, while the C-NMR spectrum facilitates the determination of carbon environments, confirming the successful incorporation of thiol moieties. Characteristic chemical shifts in the spectra provide quantitative and qualitative data regarding the degree of polymerization and functionalization of the PLA-SH polymer. This characterization is crucial to understand the physicochemical properties of PLA-SH, which enables the optimization of its application in various fields.

The H-NMR spectra reveal distinct peaks which help characterize the synthesized polymer structure, with a notable solvent peak at 7.26 ppm (Chloroform) that facilitates spectral calibration. Analysis of the main spectra indicates five unique proton environments: (1) a thiol (—SH) proton, (2) a methylene group (—CH₂) bound directly to sulfur, (3) a neighboring methylene (—CH₂) in the beta position relative to sulfur, (4) a methyl group (—CH₃) in the ester moiety, and (5) an isolated proton in the ester region. In the 5.2 ppm region, a complex multiplet pattern (two overlapping quadruplets and a quadruplet) indicates the presence of distinct polymer chains. While a higher frequency (e.g., 1 GHZ) could provide better resolution, the spectra already suggest the formation of three polymer products. The 4.2 ppm region shows two quadruplets consistent with —CH₂ protons adjacent to oxygen, while the 3.7 ppm triplet, likely from a thiol-connected proton, implies a broken symmetry around sulfur. A quadruplet at 2.7 ppm corresponds to —CH₂ linked to sulfur, further reinforcing the structural assignment. Peaks at 1.0 ppm suggest incomplete reaction, as integration values differ from expected stoichiometric ratios, indicating only approximately 70% reaction completion and suggesting the presence of unreacted starting material. The integration suggests three product types with variable chain lengths, further corroborated by mass spectrometry, which shows a distribution of chain lengths from n=12 to n=26. This distribution highlights the need for optimized reaction conditions to yield a single, dominant polymer species, as reflected by both MS and NMR patterns.

### Fourier Transform Infrared Spectroscopy

Fourier Transform Infrared (FTIR) Spectroscopy is a key technique widely used to identify functional groups and characterize chemical structures in various materials, including polymers. This method provides detailed insights into the molecular interactions within the polymer matrix. FTIR analysis spectra displays characteristic absorption bands corresponding to specific chemical bonds, that facilitates the confirmation of thiol (—SH) groups and lactate ester functionalities in PLA-SH.

The FTIR spectrum for the synthesized PLA-SH shows various peaks that correspond to different functional groups in the material. The peaks 2994.92 cm⁻¹ and 2945.00 cm⁻¹ correspond to the stretching vibrations of C—H bonds in methyl and methylene groups, indicating the presence of aliphatic hydrocarbons typically found in PLA. The peak at 1746.15 cm⁻¹ attributes to the carbonyl (C═O) stretching of the ester group in PLA confirms the ester functional group, which is characteristic of PLA. Similarly, 1451.83 cm⁻¹ associates with bending vibrations of C—H bonds, 1381.01 cm⁻¹ is related to the bending vibrations of —CH₃ groups, 1363.38 cm⁻¹ also linked to C—H bending vibrations and 1267.34 cm⁻¹ indicates the C—O stretching in the ester. The peak at 1182.69 cm⁻¹ is related to C—O—C stretching, indicates the presence of the ester linkage in the polymer. Peaks at 1127.69 cm⁻¹ and 1050.10 cm⁻¹ determines the C—O stretching. Peak at 864.25 cm⁻¹ attributes to C—H bending or other low-energy vibrations associated with the polymer structure, and 751.67 cm⁻¹ relates to out-of-plane bending vibrations.

The presence of these peaks suggests that the polymer maintains its characteristic structure as PLA, with the added thiol (—SH) functionality likely influencing its reactivity and properties. Peaks corresponding to the carbonyl and ether linkages in the ester groups indicate successful synthesis of PLA-SH, confirming the integrity of the polymer backbone. This FTIR spectrum provides insight into the molecular structure of PLA-SH, affirming the presence of key functional groups that define its chemical identity. The peaks corresponding to C—H, C—O, and C—O confirm that the thiolated PLA retains its characteristic features while incorporating thiol functionality, which could enhance its applications

Surface Functionalization of usGNP with PLA-SH by Phase Transfer Method

Surface functionalization involves the modification of a material's surface to introduce specific chemical groups or molecules, thereby imparting desired properties or functionalities. This technique is widely employed to tailor the surface characteristics of materials such as nanoparticles and polymers for applications in drug delivery, catalysis, biosensing, and tissue engineering. By introducing functional groups, such as thiols, amines, or carboxyl groups, or attaching biomolecules like antibodies and peptides, surface properties including hydrophilicity, biocompatibility, and reactivity can be precisely controlled to optimize interactions with the surrounding environment or target molecules.

In this study, the surface functionalization of usGNPs with PLA-SH is conducted to enhance the nanoparticles' stability, biocompatibility, and targeting capabilities. The thiol (—SH) groups present in PLA-SH serve as effective binding sites that enable strong interactions with the surface of the usGNPs.

A previously reported procedure for the functionalization of large gold nanoparticles was adapted to accommodate usGNPs. The surface functionalization of usGNPs with PLA-SH was achieved via a phase transfer method. Specifically, 2 mL of prepared usGNPs in aqueous media, obtained from both methods, were added to separate Falcon tubes containing an equal volume of dichloromethane with PLA-SH. The concentrations of both usGNPs and PLA-SH were optimized to ensure effective functionalization. The mixture was subjected to vigorous shaking to enhance the interaction between the usGNPs and PLA-SH. Following this, 3 mL of methanol was introduced to facilitate the transfer of usGNPs from the aqueous phase to the organic phase. After sufficient time was allowed for phase transfer, the lower organic phase was collected, and the organic solvent was allowed to dry. This process yielded a dried film of PLA-functionalized usGNPs (PLA-usGNPs), which was subsequently prepared for characterization.

TABLE 7
Comparison of UV-Vis Spectra Obtained between Unmodified
usGNP and Surface Functionalized usGNP

| | Wavelength (nm) |
|---|---|
| usGNP/No cap | 512-515 |
| PLA-SH-usGNP/No cap | 516-519 |
| usGNP/Cit | 509-518 |
| PLA-SH-usGNP/Cit | 512-519 |

usGNPs synthesized without a capping agent exhibited a SPR peak at 512-515 nm. After surface functionalization with PLA-SH, the UV-Vis spectra shifted to a higher range of 516-519 nm. This red shift in absorbance was attributed to the strong covalent bonding between the thiol groups of PLA-SH and the gold surface, which alters the electronic environment and increases the effective particle size. Similarly, usGNPs capped with sodium citrate showed a maximum absorbance spectrum between 509-518 nm, which shifted to 512-519 nm upon functionalization with PLA-SH. This shift was attributed to the strong covalent interactions between the thiol groups of PLA-SH and the gold surface, which modified the electronic environment and may have increased the effective size of the nanoparticles. This is primarily due to the replacement of the citrate capping agent with PLA-SH, which alters the local dielectric environment. PLA-SH has a lower refractive index compared to sodium citrate and the aqueous medium, leading to a shift in the SPR wavelength.

This functionalization with PLA-SH provides steric stabilization, reducing nanoparticle aggregation, which keeps the particles well-dispersed. Additionally, the gold-thiol interaction between the nanoparticle surface and the PLA-SH thiol groups may subtly influence the electronic properties of the nanoparticles, further contributing to the shift. Overall, this spectral shift reflects the successful functionalization and the resulting changes in both surface chemistry and optical properties of the usGNPs.

PLA-SH functionalization on uncapped usGNPs is generally more efficient and robust, as the surface of usGNPs directly interacts with the thiol groups of PLA-SH, without interference from a prior stabilizing agent like citrate. This leads to stronger usGNP-PLA-SH bonding and improved surface coverage, which enhances nanoparticle stability, reduces aggregation, and provides precise functionalization. In contrast, citrate-capped usGNPs functionalized with PLA-SH may still perform well, but the two-step process, involving citrate displacement, can result in less efficient functionalization or incomplete removal of the capping agent, potentially influencing nanoparticle behavior. Therefore, PLA-SH functionalization on uncapped usGNPs is superior due to more direct and efficient bonding, resulting in better stability, reduced surface interference, and improved performance in applications that demand precise surface modification. Consequently, a large batch of uncapped usGNPs was synthesized, functionalized with PLA-SH, and stored in acetone for further characterization and encapsulation studies.

Characterization studies on usGNP-PLA-SH are essential for several reasons, particularly for subsequent PLGA encapsulation. First, this assesses the efficiency of the functionalization process by confirming the presence of thiol groups on the nanoparticle surface, which is crucial for stability and functionality. DLS provide critical data on size and size distribution. This also helps to evaluate the stability of the functionalized usGNPs in various environments, which is vital for maintaining their integrity during the encapsulation process in PLGA. Understanding the morphology through image analysis ensures that the nanoparticles can be effectively incorporated into PLGA matrices without aggregation or structural changes. Furthermore, insights into the optical properties, including SPR, are vital for applications in imaging and sensing, where the performance of the final product may depend on these properties. Overall, these characterization studies ensure that the functionalized usGNPs meet the specific requirements for their intended applications, particularly in PLGA encapsulation.

TABLE 8
Characterization of Optimized PLA-SH-usGNP

| | | | | Maximum |
|---|---|---|---|---|
| | Particle size | | Zeta | wavelength of |
| Method/Sample | (Hydrodynamic | Polydispersity | potential | the plasmon |
| No | diameter, nm) | index | (mV) | peak (nm) |
| PLA-SH-usGNP | 21.98 ± 1.76 | 0.38 ± 0.04 | −23.23 ± 0.97 | 524 |
| in acetone | | | | |

The synthesis of usGNP without a capping agent yielded maximum absorbance spectra in the range of 509-518 nm, which exhibited a notable shift to 524 nm after functionalization with PLA-SH. This shift resulted from the collective oscillation of conduction electrons in response to incident light, altering the nanoparticles optical characteristics. Covalent bonding with PLA-SH increased the effective particle size by adding a polymeric layer and modifying interparticle distances, reducing coupling effects among closely spaced nanoparticles. The observed red shift in the UV-Vis spectra of PLA-SH-functionalized usGNPs underscored the significant impact of surface modification on the nanoparticles' plasmonic behavior.

The size increase of PLA-usGNP from less than 5 nm to approximately 24 nm following surface functionalization with PLA-SH was observed. This increase likely resulted from the formation of a polymeric shell as PLA-SH molecules, bearing thiol (—SH) groups, chemisorbed onto the nanoparticle surface via strong gold-thiol interactions, creating a surrounding polymer layer. Additionally, surface modification with PLA-SH may have stabilized the nanoparticles against aggregation, allowing for a more uniform, dispersed state with a larger effective hydrodynamic size [34]. The zeta potential also shifted from −13.3 mV to −23.23 mV following surface functionalization with PLA-SH, which can be attributed to the addition of negatively charged groups from the polymer coating. The PLA-SH molecules formed a stable coating around the nanoparticle surface through thiol-gold interactions, with negatively charged groups from the polylactic acid backbone contributing to an increase in surface charge density. This shift in zeta potential reflects enhanced electrostatic repulsion, indicating improved colloidal stability post-functionalization. Such increase in negative zeta potential upon polymer coating have been documented in similar nanoparticle functionalization studies [35].

Encapsulation of Resulting PLGA-usGNP into PLGA Nanoparticle by Nano-Precipitation Method

Polymeric nanocarriers such as PLGA are widely used in clinical settings due to their biocompatibility and versatility. PLGA nanoparticles are typically prepared using two main methods: the nanoprecipitation method and the emulsion-evaporation method. In the nanoprecipitation method, PLGA is dissolved in a water-miscible organic solvent, such as acetone, and precipitated into nanoparticles upon addition into a nonsolvent, like water. In the emulsion-evaporation method, PLGA is dissolved in a water-immiscible organic solvent, such as dichloromethane, which is then emulsified in an aqueous external phase, followed by solvent evaporation to form nanoparticles [18]. These PLGA nanoparticles are ideal for encapsulating usGNPs, aiding in imaging and quantification. Efficient encapsulation requires dissolving both the PLGA polymer and usGNP-PLA-SH in the chosen organic solvent (acetone or dichloromethane), enabling the PLGA nanoparticles to successfully encapsulate the functionalized usGNPs. PLGA-usGNP will be suspended in acetone, into which, PLGA polymer will be added and dissolved. PLA-usGNP/PLGA mixture in acetone will then be added drop wise to deionized water with stirring. Upon the fast diffusion of acetone into water, the PLGA nanocarriers will form and simultaneously encapsulate the PLA-usGNP. PLGA with terminal carboxylic acid ensure negative effective surface charge and thus adequate colloidal stability of the resulting PLGA nanocarriers. Residual acetone will be removed by stirring the nanoparticle suspension overnight or using a rotary evaporator. Encapsulation will be optimized considering PLA-usGNP: PLGA and acetone: water ratio. Moreover, the effect of the presence of various typically used surfactants (e.g., polyvinyl alcohol and polyvidone) and their concentration on the size, charge and colloidal stability of the resulting PLGA nanocarriers will be investigated and optimized. Encapsulation will be evaluated in term of encapsulation efficiency, load tunability and colloidal stability of resulting labelled PLGA nanoparticles. Au+ concentration in PLGA nanoparticles will be measured using ICP-MS analysis. Hydrodynamic diameter and polydispersity index (PDI) of prepared PLGA nanoparticles will be measured by DLS size analysis using Zetasizer

Purification of usGNP-PLA-SH

Two Eppendorf tubes were labeled, and 0.5 mL of stock solution containing PLA-usGNP in acetone was added to each tube, yielding a total of 1 mL in each. The tubes were then centrifuged at 10,000 rpm for 10 mins. After centrifugation, the supernatant was carefully decanted, leaving the pellet behind. To each pellet, 0.5 mL of acetone was added, and the pellet was thoroughly dispersed. The tubes were centrifuged again at 10,000 rpm for 10 mins, and the supernatant was decanted again. 0.5 mL of acetone was then added to both tubes, and the dispersed pellets were pooled into a single Eppendorf tube. This final solution represents the purified PLA-usGNP in acetone (FIG. 18a). The Eppendorf tube was sealed with paraffin and stored at 4° C. for encapsulation.

Preparation of PLGA and Integration with Purified usGNP-PLA-SH

In a clean Eppendorf tube, 0.4 mL of purified PLA-usGNP in acetone was added. Subsequently, 5 mg of PLGA (Resomer® RG 502, Poly (D, L-Lactide-co-Glycolide) lactide: glycolide 50:50, ester terminated, Mw 7,000-17,000) was carefully measured and introduced into the tube. The mixture was allowed to stir until the PLGA was fully dissolved, ensuring homogeneity of the solution to give PLA-usGNP-PLGA solution (FIG. 18c).

Preparation of 1% PVA and Integration with Purified PLA-usGNP-PLGA Mixture

A total of 100 mg of PVA powder (molecular weight 85K-124K) was accurately weighed. Separately, 10 mL of Milli-Q water was heated to approximately 60-70° C., ensuring the water did not reach a boiling point. The PVA powder was then slowly added to the water while stirring continuously to prevent clumping. The solution was stirred for 15-30 minutes using a magnetic stirrer and left overnight under continuous stirring to ensure complete dissolution. By the following day, the PVA was fully dissolved, resulting in a clear solution, which was then allowed to cool to room temperature before use.

A clean 15 ml beaker and magnetic bead were taken and thoroughly rinsed with aqua regia and Milli-Q water, followed by complete drying. This was again rinsed with acetone and allowed to dry completely. The cleaned beaker was placed on a magnetic stirrer, with a magnetic bead. To which, 7.0 mL of freshly prepared 1% PVA solution was added, and the mixture was stirred at a low speed. Following this, 0.4 mL of the completely dispersed PLA-usGNP-PLGA solution was added drop-wise into the beaker containing the 1% PVA solution. The mixture was left to stir overnight inside the biosafety hood to ensure complete removal of acetone (FIG. 18c).

### Centrifugation and Purification of PLA-SH-usGNP-PLGA Nanoparticles

After 24 hours, the hazy solution remained in the beaker after stirring, was centrifuged at 12,000 rpm for 8 mins. A distinct blue and white pellet was obtained, along with a clear supernatant. The supernatant was carefully decanted, leaving behind a strong pellet identified as “PLA-SH-usGNP-PLGA NP.” The pellet exhibited two distinct colors: a white outer layer corresponding to PLGA nanoparticles and a blue center representing usGNP-PLA (FIG. 18a). This pellet was subsequently collected for further purification and characterization.

For the purification process, 1.5 mL of 1% PVA solution was added to the “PLA-SH-usGNP-PLGA-NP” pellet. The mixture was sonicated until the pellet was fully dispersed. After the addition of 1% PVA and sonication, the solution dispersed well. However, a few blue strands were observed floating in the solution. Additional minutes of sonication further reduced the presence of these debris. In order to address this issue, it was considered that optimizing the capping agent by increasing the concentration of PVA might improve the results. Alternatively, optimization of the centrifugation parameters was suggested, as the initial settings might have been too harsh, indicating a need for less intense centrifugation or other procedural adjustments.

To remove debris, the entire dispersed solution containing debris was centrifuged at 1,000 rpm for 10 mins. A clear supernatant was obtained, with the debris adhering to the wall of the tube. The supernatant was then transferred to a new Falcon tube, where it underwent further centrifugation at the same low speed of 1,000 rpm for an additional 10 mins. After this second centrifugation, no debris was observed in the supernatant. The supernatant containing nanoparticles free of debris was collected.

The clear supernatant solution was then centrifuged at a higher speed of 8,000 rpm for 15 mins to collect the nanoparticles. After centrifugation, PLA-usGNP-PLGA nanoparticles were obtained. This was followed with the second wash, where 1.5 mL of Milli-Q water was added to the nanoparticle pellet, and centrifugation was performed at 8,000 rpm for 15 mins. The supernatant was decanted, and the washing process was repeated with another 1.5 mL of Milli-Q water added to the nanoparticle pellet, and centrifugation was done at 8,000 rpm for 15 mins. After decanting all the water, the clean pellet was obtained. To which, 250 μL of water was added to show a clean and concentrated usGNP-PLA labelled PLGA nanoparticle preparation (FIG. 18c). The final product was sealed and stored at 4° C. for further characterization.

The method for synthesizing usGNP was optimized, resulting in an efficient process that produced high-quality nanoparticles. The synthesis of thiolated PLA from lactide was successfully achieved through ring-opening copolymerization, followed by purification and characterization studies that included mass spectrometry (MS), carbon nuclear magnetic resonance (C-NMR), hydrogen nuclear magnetic resonance (H-NMR), and Fourier-transform infrared spectroscopy (FTIR) to analyze the molecular structure and weight. The synthesized PLA-SH was utilized for the surface functionalization of the synthesized usGNP, and this process was confirmed successful through various characterization techniques, including UV-Vis spectroscopy, DLS, and TEM. A large batch of functionalized nanoparticles was prepared, dried, and stored by dispersing in acetone for encapsulation within PLGA nanoparticles. Encapsulation of usGNP-PLA into PLGA nanoparticles was conducted, involving washing with acetone and using a PLGA and 1% PVA solution. The encapsulation process yielded a blue and white precipitate to confirm the usGNP-PLA labelled PLGA nanoparticle, which will undergo further characterization to confirm the encapsulation efficacy.

The previous detailed description is of a small number of embodiments for implementing the invention and is not intended to be limiting in scope. One of skill in this art will immediately envisage the methods and variations used to implement this invention in other areas than those described in detail.

### REFERENCES

1. Toljan, K., et al., Nanotechnology in stroke: new trails with smaller scales. Biomedicines, 2023. 11 (3): p. 780.
2. Anselmo, A. C. and S. Mitragotri, Nanoparticles in the clinic: An update. Bioengineering & translational medicine, 2019. 4 (3): p. e10143.
3. Weissig, V. and D. Guzman-Villanueva, Nanopharmaceuticals (part 2): products in the pipeline. International journal of nanomedicine, 2015: p. 1245-1257.
4. Weissig, V., T. K. Pettinger, and N. Murdock, Nanopharmaceuticals (part 1): products on the market. International journal of nanomedicine, 2014: p. 4357-4373.
5 Alkilany, A. M., et al., PLGA-Gold Nanocomposite: Preparation and Biomedical Applications. Pharmaceutics, 2022. 14 (3): p. 660.
6. Butreddy, A., et al., PLGA/PLA-based long-acting injectable depot microspheres in clinical use: production and characterization overview for protein/peptide delivery. International journal of molecular sciences, 2021. 22 (16): p. 8884.
7. Shen, X., et al., PLGA-based drug delivery systems for remotely triggered cancer therapeutic and diagnostic applications. Frontiers in Bioengineering and Biotechnology, 2020. 8: p. 381.
8. Mahmoudi, M., et al., Emerging understanding of the protein corona at the nano-bio interfaces. Nano Today, 2016. 11 (6): p. 817-832.
9. Alkilany, A. M., S. E. Lohse, and C. J. Murphy, The gold standard: gold nanoparticle libraries to understand the nano-bio interface. Accounts of chemical research, 2013. 46 (3): p. 650-661.
10. Bouché, M., et al., Recent advances in molecular imaging with gold nanoparticles. Bioconjugate chemistry, 2019. 31 (2): p. 303-314.
11. Ximendes, E., et al., Quo vadis, nanoparticle-enabled in vivo fluorescence imaging? ACS nano, 2021. 15 (2): p. 1917-1941.
12. Thakor, A. S., et al., Clinically approved nanoparticle imaging agents. Journal of Nuclear Medicine, 2016. 57 (12): p. 1833-1837.
13. Álamo, P., et al., Fluorescent dye labeling changes the biodistribution of tumor-targeted nanoparticles. Pharmaceutics, 2020. 12 (11): p. 1004.
14. Mantri, Y. and J. V. Jokerst, Engineering plasmonic nanoparticles for enhanced photoacoustic imaging. ACS nano, 2020. 14 (8): p. 9408-9422.
15. Fan, M., et al., Ultrasmall gold nanoparticles in cancer diagnosis and therapy. Theranostics, 2020. 10 (11): p. 4944.
16. Wu, Y., et al., Gold nanoparticles in biological optical imaging. Nano Today, 2019. 24: p. 120-140.
17. Faulk, W. P. and G. M. Taylor, Communication to the editors: an immunocolloid method for the electron microscope. Immunochemistry, 1971. 8 (11): p. 1081-1083.
18. Alkilany, A. M., S. R. Abulateefeh, and C. J. Murphy, Facile functionalization of gold nanoparticles with PLGA polymer brushes and efficient encapsulation into PLGA nanoparticles: toward spatially precise bioimaging of polymeric nanoparticles. Particle & Particle Systems Characterization, 2019. 36 (2): p. 1800414.
19. Barichello, J. M., et al., Encapsulation of hydrophilic and lipophilic drugs in PLGA nanoparticles by the nanoprecipitation method. Drug development and industrial pharmacy, 1999. 25 (4): p. 471-476.
20. Poon, W., et al., Elimination pathways of nanoparticles. ACS nano, 2019. 13 (5): p. 5785-5798.
21. Yu, M., J. Xu, and J. Zheng, Renal clearable luminescent gold nanoparticles: from the bench to the clinic. Angewandte Chemie International Edition, 2019. 58 (13): p. 4112-4128.
22. Hammami, I. and N. M. Alabdallah, Gold nanoparticles: Synthesis properties and applications. Journal of king Saud university-science, 2021. 33 (7): p. 101560.
23. Gad, G. and M. A. Hegazy, Optoelectronic properties of gold nanoparticles synthesized by using wet chemical method. Materials Research Express, 2019. 6 (8): p. 085024.
24. Piella, J., N. G. Bastus, and V. Puntes, Size-Controlled Synthesis of Sub-10-nanometer Citrate-Stabilized Gold Nanoparticles and Related Optical Properties. Chemistry of Materials, 2016. 28 (4): p. 1066-1075.
25. Ghosh, S. K. and T. Pal, Interparticle coupling effect on the surface plasmon resonance of gold nanoparticles: from theory to applications. Chemical reviews, 2007. 107 (11): p. 4797-4862.
26. Abkenar, A. K. and M. Naderi, Chemical synthesis of gold nanoparticles with different morphology from a secondary source. Journal of the Iranian Chemical Society, 2016. 13: p. 2173-2184.
27. Dykman, L. A. and N. G. Khlebtsov, Gold nanoparticles in biology and medicine: recent advances and prospects. Acta Naturae ( [symbol] [symbol] [symbol] ), 2011. 3 (2 (9): p. 34-55.
28. Jans, H. and Q. Huo, Gold nanoparticle-enabled biological and chemical detection and analysis. Chemical Society Reviews, 2012. 41 (7): p. 2849-2866.
29. Jana, N. R., L. Gearheart, and C. J. Murphy, Seed-mediated growth approach for shape-controlled synthesis of spheroidal and rod-like gold nanoparticles using a surfactant template. Advanced Materials, 2001. 13 (18): p. 1389-1393.
30. Dreaden, E. C., et al., The golden age: gold nanoparticles for biomedicine. Chemical Society Reviews, 2012. 41 (7): p. 2740-2779.
31. Huang, K., et al., Size-dependent localization and penetration of ultrasmall gold nanoparticles in cancer cells, multicellular spheroids, and tumors in vivo. ACS nano, 2012. 6 (5): p. 4483-4493.
32. Amina, S. J. and B. Guo, A review on the synthesis and functionalization of gold nanoparticles as a drug delivery vehicle. International journal of nanomedicine, 2020: p. 9823-9857.
33. Raeder, H. and W. Schrepp, MALDI-TOF mass spectrometry in the analysis of synthetic polymers. Acta Polymerica, 1998. 49 (6): p. 272-293.
34. Liu, Y.-Q., et al., Surface Functionalization of Gold Nanoparticles Using Alkyne Derivatives: Applications in Chemical Sensing. ACS Applied Materials & Interfaces, 2024.
35. Cho, W.-S., et al., Surface functionalization affects the zeta potential, coronal stability and membranolytic activity of polymeric nanoparticles. Nanotoxicology, 2014. 8 (2): p. 202-211.

What is claimed is:

1. A polymer composite comprising a plurality of surface functionalized metallic nanoparticles encapsulated in polyester particles, wherein the metallic nanoparticles are functionalized with thiolated polylactic acid (PLA) or poly(lactic-co-glycolic acid) (PLGA) and the nanoparticles are less than 10 nm in diameter excluding the thiolated polylactic acid (PLA) or poly(lactic-co-glycolic acid) (PLGA).

2. The polymer composite of claim 1, wherein the nanoparticles are gold nanoparticles, silver nanoparticles, platinum nanoparticles, or nanoparticles comprising a composite of gold, silver, or platinum.

3. The polymer composite of claim 1, wherein the nanoparticles are gold nanoparticles.

4. The polymer composite of claim 1, wherein the nanoparticles are functionalized with thiolated polylactic acid (PLA).

5. The polymer composite of claim 1, wherein the nanoparticles are functionalized with thiolated poly(lactic-co-glycolic acid) (PLGA).

6. The polymer composite of claim 4, wherein the molecular weight of the PLA is between about 1,000 g/mol and 10,000 g/mol.

7. The polymer composite of claim 4, wherein the molecular weight of the PLA is between about 1,700 g/mol and 5,000 g/mol.

8. The polymer composite of claim 4, wherein the molecular weight of the PLA is between about 1,700 g/mol and 2,500 g/mol.

9. The polymer composite of claim 4, wherein the molecular weight of the PLA is between about 2,500 g/mol and 5,000 g/mol.

10. The polymer composite of claim 1, wherein the nanoparticles are 5 nm in diameter excluding the thiolated polylactic acid (PLA) or poly(lactic-co-glycolic acid) (PLGA).

11. The polymer composite of claim 1, wherein the nanoparticles are less than 5 nm in diameter excluding the thiolated polylactic acid (PLA) or poly(lactic-co-glycolic acid) (PLGA).

12. The polymer composite of claim 1, wherein the nanoparticles are less than 30 nm including the thiolated polylactic acid (PLA) or poly(lactic-co-glycolic acid) (PLGA).

13. The polymer composite of claim 1, wherein the nanoparticles are about 20 nm including the thiolated polylactic acid (PLA) or poly(lactic-co-glycolic acid) (PLGA).

14. The polymer composite of claim 1, wherein the polyester particles comprise polylactic acid (PLA), poly(lactic-co-glycolic acid) (PLGA), or polylactone.

15. The polymer composite of claim 1, wherein the polyester particles comprise poly(lactic-co-glycolic acid) (PLGA).

16. The polymer composite of claim 1, comprising a plurality of surface functionalized gold nanoparticles encapsulated in poly(lactic-co-glycolic acid) (PLGA) particles, wherein the gold nanoparticles are functionalized with thiolated polylactic acid (PLA) and are 5 nm or less in diameter excluding the thiolated polylactic acid (PLA).

17. A method of preparing the polymer composite of claim 16, comprising steps (a)-(d):
a. Mixing chloroauric acid (HAucl₄) with sodium borohydride to afford gold nanoparticles wherein the gold nanoparticles;
b. Conducting ring opening copolymerization of lactide in the presence of 2-hydroxyethyl disulfide and stannous octoate and subsequent reduction in the presence of DL-dithiothreitol to afford thiolated poly(lactic acid) (PLA-SH);
c. Surface-functionalizing the gold nanoparticles with the PLA-SH via the phase transfer method to afford gold nanoparticles functionalized with PLA-SH; and
d. Encapsulating the gold nanoparticles functionalized with PLA-SH in poly(lactic-co-glycolic acid) (PLGA) nanoparticles via nanoprecipitation to afford the polymer composite.

18. The method of claim 17, wherein step (a) further comprises mixing HAucl₄ with sodium citrate.

19. The method of claim 17, wherein in step (c), the phase transfer method is conducted in the presence of water and methanol.

20. The method of claim 17, wherein step (d) comprises step (d.1): adding PLGA to the gold nanoparticles functionalized with PLA-SH in acetone and allowing the mixture to stir and step (d.2): adding the mixture from step (d.1) dropwise to water with stirring to form the polymer composite.
